(19) United States
(12) Patent Application Publication
(10) Pub. No.: US 2008/0207268 A1
(43) Pub. Date: Aug. 28, 2008

(54) Apparatus for a Removable Wireless Module With Storage Memory

(75) Inventor: Alfred Tom, San Francisco, CA (US)

Correspondence Address: THELEN REID BROWN RAYSMAN & STEINER LLP, P.O. Box 640640, SAN JOSE, CA, 95164-0640, US

(73) Assignee: Kantan Inc.

(21) Appl. No.: 11/814,676

(22) PCT Filed: Jan. 13, 2006
(86) PCT No.: PCT/US06/01325

§ 371 Date: Jul. 25, 2007

Related U.S. Application Data
(60) Provisional application No. 60/653,686, filed on Feb. 17, 2005.

(51) Int. Cl. H04B 1/38

(52) U.S. Cl. 455/558

(57) ABSTRACT

A smart modular wireless device is divided into two main parts

the cartridge which contains wireless components and the shell which contains non-wireless components. The cartridge further includes storage memory that is accessible to the shell via a removable interface. The shell may use the storage memory on the cartridge to store user data. The user data may be the primary data for software on the shell. The shell may also backup data to a file stored on the cartridge. The shell may also synchronize data with a file on the cartridge. The cartridge may be inserted into a second shell with software that may support a different format of user data as the first shell. The second shell may synchronize its own user data with the synchronization file on the cartridge, thereby keeping its own user data file substantially similar to the first shell's user data file. This synchronization between user data and synchronization files can happen manually or automatically in the background to give the user the appearance that the first and second shell are accessing the same user data when the cartridge is swapped between them.

This application claims priority to and incorporates by reference U.S. patent application Ser. No. 60/653,686 filed Feb. 17, 2005.

### FIELD OF THE INVENTION

The present invention is generally directed to wireless communication devices and related apparatus. More particularly, this invention relates to a wireless device that incorporates a reusable wireless core with storage memory.

### BACKGROUND OF THE INVENTION

The components of a wireless device can be separated into two categories- wireless components and non-wireless components. Wireless components include a baseband section, a RF section, an antenna, a wireless identity, and/or call-processing software. The call-processing software is sometimes called the “protocol stack”. Non-wireless components are comprised of everything else, which may include a keypad, a display, a battery, a speaker, and/or a microphone.

There are at least three architectures used in wireless devices today. The first architecture, utilized by the large handset vendors such as Nokia and Motorola, puts both wireless and non-wireless components on a single circuit board. The second architecture, used by smaller vendors such as Palm and Danger, puts some or all of the wireless components on a separate board called a wireless module and leaves the non-wireless components on the main circuit board. The wireless module is affixed to the circuit board. In this architecture the antenna is connected to the main circuit board and it not included in the wireless module. The third architecture improves on the second architecture by making the wireless module into a cartridge that can be removed from the device at any time, and also adding an antenna to the cartridge. The first example of this third architecture is the platform, code-named Hyrda, invented by Alfred C. Tom and covered by U.S. Pat. No. 6,690,947 B1. All “third architecture” systems today derive from this original Hydra concept.

Hereinafter, the bundle of wireless components (whether contained in a removable card or not) will be collectively referred to as the “cartridge”. The bundle of non-wireless components can be collectively referred to as the “shell”. The antenna may reside in the cartridge, in the shell, or in both locations. In some embodiments of the invention, the cartridge may be devoid of all wireless components except for the wireless identity.

Modular wireless devices are those in which there is a separation between the cartridge and shell. One purpose of modularity is to help with the design process. It is easier to design and debug a modular device than a non-modular device. In the case of devices that conform to the third architecture, modularity also enables flexibility with air-interface standards since cartridges that support different standards can be interchanged. For example, a GSM cartridge can easily be replaced by a CDMA cartridge.

Another benefit of modular wireless devices is allowing consumers to own multiple shells and use just one cartridge in all the shells. This allows the consumer to not only gain flexibility, but also (in some cases) reduce cost. Instead of buying 3 devices all with wireless components, the consumer can by 3 shells and one cartridge. The combination of 3 shells and one cartridge may be cheaper than 3 integrated devices because the shells do not contain expensive wireless components and the wireless components need not be duplicated in each shell.

The problem with this usage model is that there is not an easy way for all shells to maintain the same data. For example, if a consumer takes a picture on a shell with a camera and then adds a phone number to the shell's address book, the consumer would want this new picture and phone number to be accessible when using the other shells as well. Today, the way to achieve this is to store data on a memory card separate from the cartridge and move this card from shell to shell. This is inconvenient since the consumer needs to move two pieces of hardware (for example the memory card and the SIM card) from shell to shell to maintain data consistency. Also, if the two shells use different file formats to store data they cannot share the same file, and the ability to maintain consistent data between the two shells is lost. Another solution is to have all the shells connect to each other, wirelessly or otherwise, and synchronize data. However, it is difficult to maintain synchronized data in this fashion when more than 2 devices are used interchangeably.

Some PC cards bundle communication and storage on one card. However, these PC-cards have several drawbacks. Among other things, they do not have the ability to use an antenna in the device, which improves radio performance and gives designers flexibility with industrial design. Furthermore, they do not support 2-way analog audio communications which is almost required for voice. Last, devices with different file storage structures cannot use the same data on a PC card. For example, if a Windows Mobile device stores a phone number in the card using a PAB file, this phone number cannot be read by a device that uses the PalmOS because the Palm address book cannot read PAB files.

Other expansion card standards, such as Secure Digital Input/Output (SDIO), can also bundle communication and storage on one card. Some standards even have a serial interface that is simpler than PCI. However, none have the ability to use an antenna in the device, nor the ability to share a single driver across cards for different air-interface standards, nor the ability to conduct 2-way analog audio communications for voice, nor the ability to share data files across different file formats.

SIM cards store both phone numbers and wireless identity, but they have different formats according to which standard they support (e.g.—a GSM SIM card is different from a CDMA R-UIM card) which leads to confusing incompatibilities between devices and SIM cards. Furthermore, the SIM card memory is limited in the size and type of data is can store-only a few phone numbers can be stored on SIM card, and storing large files like images are impossible.

In fact, the shared data file problem is not only applicable to wireless cartridges. It is equally applicable to generic storage cards without wireless capability like SD cards and USB flash drives. As mentioned above, a single storage card can be plugged into different wireless devices, but if the software in the two devices use different file structures for storing data, the information on the storage card cannot be shared between the handsets.

The industry needs a simple way to maintain consistent data files in a wireless cartridge with storage. The present invention addresses this need.

### SUMMARY OF THE INVENTION

A wireless device may be split into two parts—the shell which may contain the non-wireless components, and the cartridge which may contain the wireless components along with data storage components. The shell and cartridge may be removably connected by an interface. The shell may have a mechanism to access the storage components in the cartridge and perform operations such as read and write data to and from the storage components. The cartridge may have a connection to an antenna in the shell through the interface. The cartridge may also have its own antenna. The cartridge may contain wireless components such as a protocol stack and/or wireless identity. The shell and cartridge may communicate over the interface via a serial protocol or a parallel protocol. In an embodiment, the cartridge may be limited to containing just storage and wireless identity.

The shell may have direct access to the storage components in the cartridge through pins on the interface. Or the shell may access the storage components indirectly by communicating through a microprocessor in the cartridge. Software on the shell may store data files in the storage on the cartridge. These data files may use proprietary formats specific to a particular software application, or they may use open formats with widely published specifications. When a cartridge is swapped between two shells or more, software applications on the different shells may access the same data files to maintain data consistency among different shells.

Software on the shell may access data files stored either on the cartridge or off the cartridge. This software may have the capability to backup the data in these files to a backup file in the cartridge. When the cartridge with this backup file is inserted into a second shell, the software in the second shell may restore data from the backup file into its own data files. Thus, software in two shells may use different data file formats, yet use the same backup file so that the data used by software on the two shells are the same.

Software on the shell may synchronize its data file with a synchronization file on the cartridge. The synchronization file may be the same as the backup file, or it may be different. When the cartridge is inserted into a second shell, the software in the second shell may synchronize its data files with the synchronization file in the cartridge. Thus, software in two shells may use different data file formats, yet synchronize with the same synchronization file in the cartridge to maintain data consistency.

The backup and synchronization routines may happen with user intervention, or automatically. Automatic synchronizations may happen at regular intervals, after an application is closed, when a data change is made, or any other time that does not require user intervention. The methods for synchronizing data, backing up data to a backup file, and restoring data from a backup file are well known to those of ordinary skill in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating a modular wireless device shell that uses a cartridge with storage memory.

FIG. 2 is a diagram illustrating a combo wireless/storage cartridge with separate memory for a protocol stack (application memory) and user data (storage memory).

FIG. 3 is a diagram illustrating a combo wireless/storage cartridge with separate memory for the protocol stack (application memory) and storage. The processor and storage memory behave like USB slave devices controlled by the shell via USB pins on the interface.

FIG. 4 is a diagram illustrating a combo wireless/storage card whose memory is used for both storage and application memory. Both the processor and shell have direct access to the memory (the shell has access through the interface).

FIG. 5 is a diagram illustrating two shells that use one cartridge—a first shell with a software application that stores data files on memory in the cartridge via a data bus, and a second shell that can receive the cartridge and access the same files in the cartridge via a data bus.

FIG. 6 is a diagram illustrating a shell and a cartridge. The cartridge contains memory that holds the data file of software on the shell. The shell backs up this data file to a backup file also in the cartridge.

FIG. 7 is a diagram illustrating a shell and a cartridge. The cartridge contains memory that holds the data file of software on the shell. The shell synchronizes this data file with a synchronization file also in the memory.

FIG. 8 is a diagram illustrating two shells and a cartridge. Software on the shells maintain incompatible data files, but these two data files are synchronized with the same synchronization file.

FIG. 9 is a diagram illustrating a cartridge that comprises minimal components: wireless identity and storage.

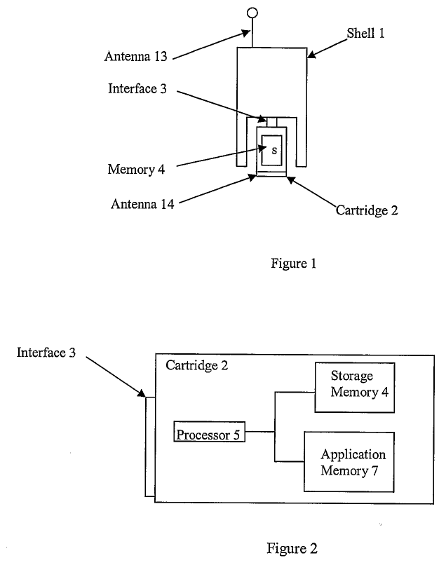

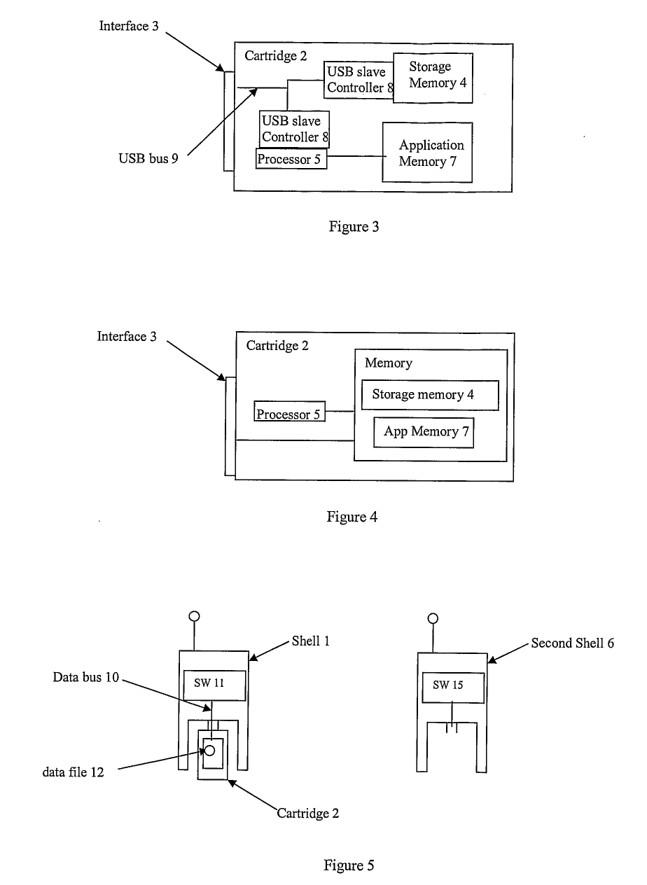

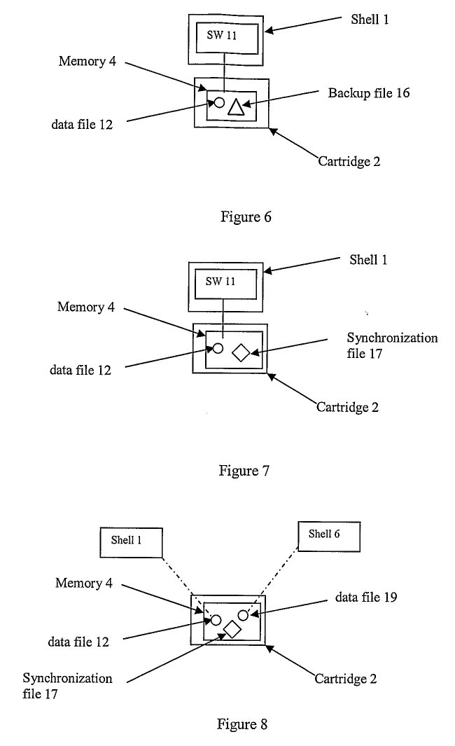

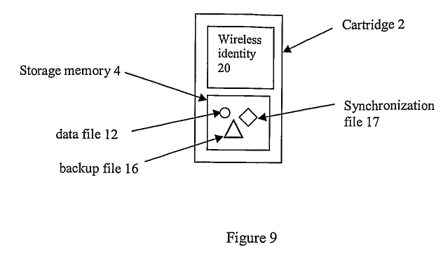

### DETAILED DESCRIPTION OF THE INVENTION

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

A wireless device may be split into two or more components that may be removably attached. At least one “shell” component 1 may contain user-interface sub-components including but not limited to a keypad, display, and microprocessor. At least one other cartridge 2 component may include a memory 4 for storing user data. The cartridge 2 may include wireless components such as, but not limited to, a software call-processing stack or wireless identity 20 components used to identify and/or authenticate the wireless device. The cartridge 2 may also include an antenna 14.

The wireless identification components may include a unique serial number, a phone number, and/or authentication components. The unique serial number may be an ESN number or an IMEI number. The phone number may be an IMSI number or a MIN number. The authentication components may include an authentication key such as an A-key or Ki. This identification information may be removable from the cartridge 2. For example, the cartridge 2 may contain a card holder for holding a SIM or R-UIM card.

The shell 1 and cartridge 2 component may communicate with each other using electrical signals over an interface 3 connecting the two components. The method of transmission may be a serial protocol, such as RS-232 or USB, or a parallel bus protocol such as PCI, or a combination of serial and parallel protocols. The interface 3 may allow the cartridge 2 to connect to an antenna 13 in the shell 1. The shell 1 and cartridge 2 may also communicate analog audio signals over the interface 3.

The interface 3 may contain pins that are used for transferring user data to and from the memory 4 in the cartridge 2. The memory 4 may be flash memory, MRAM memory, hard-drive memory, or any other type of memory for storing files. The pins may support a parallel data bus such as found in the PCI, PCMCIA, or Compactflash standard, or the pins may support a serial data bus such as found in the USB, SD Card, or MemoryStick standard. The parallel scheme may be used to increase bandwidth in some cases. The serial scheme may be used to save on the number of pins required on the interface 3. The pins may be dedicated to the purpose of transferring user data, or the pins may also have another function such as sending communication signals to the call-processing (“protocol”) stack in the cartridge 2. If the pins have more than one function, a USB bus 9 may be used to send both memory and communication signals over the pins.

The cartridge's storage memory 4 may be separate from the memory 7 used by the protocol stack, or it may be the same memory as used by the protocol stack. The storage memory 4 may be accessible directly from the shell 1, or may be accessible by the shell 1 indirectly through a processor 5 in the cartridge.

The shell 1 may contain software 11 that stores data in files 12. These files 12 may store user data. User data may include information for an application 11 such as an address book, a database, a collection of media files such as JPEG, MP3, and MP4, or any other file that contains information used by an application 11. The data files 12 may be stored in the cartridge memory 4 or on the shell 1. If the cartridge 2 has data files 12 and is inserted into a second shell 6, software 15 in this second shell 6 may access the same data files 12 in the cartridge 2. Many other shells may also have software that can access the same data files 12 in the cartridge 2. Thus, two or more shells can use the same data files 12 so that the consumer maintains data consistency when swapping cartridges between shells. In one embodiment, a software application 11 in the shell 1 may store its address book and digital image files 12 in the cartridge memory 4. When the cartridge 2 is inserted into a second shell 6, a software application 15 in the second shell 6 may be a different application to the application 11 in the first shell 1, yet understand how to read the address book and image files 12 in the cartridge 2. So, this application 15 may read these files and modify them just like the first application 11 did.

The shell 1 may have software 11 that has the capability to backup the data files 12 to a separate backup file 16 in the cartridge's memory 4. The shell 1 may back up user data to a backup file 16 stored in the memory 4 on the cartridge 2 so that the backup file 16 contains substantially the same information as contained in the data file 12. In one embodiment, the shell software application 11 may read a data file 12 and export the contents to a backup file 16 on the cartridge 2. The backup file 16 may have a different file format than the data file 12. The cartridge 2 may be removed and put into a second shell 6. The second shell 6 may restore user data from the backup file 16 on the cartridge 2 to its own data file 19, so that the user data contained in the backup file 16 can now be accessed by both the second shell 6 and the first shell 1. The second shell's data file 19 may have a different format than the backup file 16 or the first shell's data file 12. In one embodiment, a software application on the second shell 15 may import the backup file 16 and write its contents to the application's own data file 19. The first shell 1 and second shell 6 may use an industry standard protocol like SyncML to backup and restore user data between the shell 1 and cartridge 2. The backups may happen automatically in the background, at periodic intervals, right after a software application is closed, right after a software application is moved to the background, when there is a change in the data file 12, or at any other time. In this way, a user may go from one shell to the next and still keep the same user data between shells.

The shell 1 may synchronize a user data file 12 with a synchronization file 17 in the cartridge's memory 4. The synchronization file 17 may be substantially the same file as the backup file 16 or it may be a different file. In one embodiment, a software agent on the shell 1 may read both the user data file 12 and the synchronization file 17. Using synchronization techniques commonly known in the industry, the agent may determine how the data file 12 and the synchronization file 17 need to be updated to remain synchronized, and write these updates to the data file 12 and the synchronization file 17, leaving the data file 12 and the synchronization file 17 with substantially the same information. The agent may run in the background on the shell 1 and be invisible to the user. The agent may automatically perform synchronizations to keep the synchronization file 17 and data file 12 synchronized. The cartridge 2 may be removed and put into a second shell 6. An agent on the second shell 6 may then synchronize the second shell's data file 19 with the synchronization file 17 on the cartridge 2 so that the second shell data file 19 is updated with the latest changes to the first shell data file 12. The second shell 6 may use the same synchronization techniques as the first shell 1, or different synchronization techniques. The second shell data file 19 may be in the shell 6 or in the cartridge 2. The first shell 1 and second shell 6 may use an industry standard protocol like SyncML to synchronize user data files 12 19 with the synchronization file 17. The synchronization may happen automatically in the background at periodic intervals, or right after a software application is closed, or when there is a change in the data, or at any other time. Thus, the two shells 1 and 6 can maintain incompatible data files 12 and 19 yet still use the same user data.

The foregoing description of the illustrated embodiments of the present invention is by way of example only, and other variations and modifications of the above-described embodiments and methods are possible in light of the foregoing teaching. For example, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A modular wireless device comprising:
a shell that contains non-wireless components, at least one of which is system software;
a cartridge that contains wireless components and storage memory;
an interface that connects the shell and cartridge, including a bus for the shell to store data in said storage memory of said cartridge.

2. (canceled)

3. (canceled)

4. The modular wireless device as recited in claim 1 wherein the interface includes a removable connection.

5 . The modular wireless device as recited in claim 1 wherein the shell includes an antenna that is accessible by the cartridge through the interface.

6. (canceled)

7. The modular wireless device as recited in claim 1 wherein the interface contains pins dedicated to communicating 2-way audio signals between the cartridge and shell.

8. (canceled)

9. (canceled)

10. (canceled)

11. (canceled)

12. (canceled)

13. (canceled)

14. (canceled)

15. (canceled)

16. The modular wireless device as recited in claim 1 wherein the storage memory is separated into at least two parts; the two parts including one part for storing user data and a second part for running protocol stack software.

17. The modular wireless device as recited in claim 1 wherein the storage memory is used for both storing user data and for running protocol stack software.

18. The modular wireless device as recited in claim 1 wherein the shell accesses the storage memory indirectly through a microprocessor in the cartridge.

19. The modular wireless device as recited in claim 1 wherein the shell accesses the storage memory directly through the interface that connects the shell and cartridge.

20. The modular wireless device as recited in claim 1 wherein the system software further includes application software that is capable of storing a user data file in the cartridge storage memory.

21. (canceled)

22. (canceled)

23. The modular wireless device as recited in claim 1 wherein the system software is capable of storing a backup data file in the cartridge storage memory.

24. The modular wireless device as recited in claim 23 wherein the system software is further capable of automatically creating the backup data file.

25. The modular wireless device as recited in claim 23 wherein the system software is further capable of synchronizing a user data file with the backup data file.

26. The modular wireless device as recited in claim 25 wherein the software in the shell is further capable of automatically synchronizing the files.

27. (canceled)

28. A modular wireless device cartridge comprising:
a cartridge that contains wireless components, storage memory, and an interface configured for removable connection to a shell that contains non-wireless components, at least one of which is system software, wherein the interface gives the shell access to the wireless components and storage memory in the cartridge.

29. The modular wireless device cartridge as recited in claim 28 wherein one of the wireless components comes from the set consisting of wireless protocol stack baseband section and RF section.

30. (canceled)

31. (canceled)

32. The modular wireless device cartridge as recited in claim 28 wherein the removable connection to the shell further connects to an antenna in the shell.

33. The modular wireless device cartridge as recited in claim 28 wherein the interface includes pins dedicated to communicating 2-way audio signals over the interface.

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. A modular storage device comprising:
a shell that contains non-wireless components, at least of one of which is system software and another of which is an interface configured for connection to a removable cartridge that contains storage memory; and
a bus for storing data on said storage memory in the cartridge using the interface.

66. (canceled)

67. (canceled)

68. (canceled)

69. The modular storage device as recited in claim 65 wherein the stored data includes a synchronization file; and
the system software further includes application software that has a user data file; and
the system software is capable of synchronizing the user data file with the synchronization file.

70. The modular storage device as recited in claim 69 wherein the user data file is on the shell.

71. The modular storage device as recited in claim 69 wherein the user data file is on the cartridge.

72. The modular storage device as recited in claim 69 wherein the system software is capable of synchronizing the files automatically.

73. The modular storage device as recited in claim 65 wherein interface further includes pins dedicated to communicating 2-way audio signals to the cartridge.

74. (canceled)

75. (canceled)

76. (canceled)

77. (canceled)

78. (canceled)

79. The modular storage device as recited in claim 65 wherein the system software is capable of creating a backup file on the cartridge automatically.
